(19) United States
(12) Patent Application Publication
(10) Pub. No.: US 2021/0351945 A1
(43) Pub. Date: Nov. 11, 2021

(54) CONFERENCE FACILITATION SYSTEMS AND METHODS

(71) Applicant: CONFERENCE ME IN, INC., Gardena, CA (US)

(72) Inventors: Heather L. Rasmussen, Gardena, CA (US); Robert A. T. Tweedie, Rancho Mission Viejo, CA (US)

(21) Appl. No.: 16/870,002

(22) Filed: May 8, 2020

(51) Int. Cl. H04L 12/18; G06F 9/54

(52) U.S. Cl. CPC H04L 12/1818; G06F 9/54; H04L 12/1822

(57) ABSTRACT

Systems and methods are provided for conference event initiation and may include: a calendar API accessing a user calendar and retrieving upcoming conference events for the user on the calendar; a parsing module parsing the retrieved upcoming conference events and storing event information for the upcoming events in an event database, wherein the event information comprises event sign-on information; and at a first predetermined time prior to a scheduled conference event, a call module: initiating a call to a host system for the scheduled conference event; placing a call to the user at a second predetermined time prior to the scheduled conference event; and merging the call to the user with the call to the host system to join the user to the scheduled conference event.

### TECHNICAL FIELD

The present disclosure relates generally to conferencing systems, and in particular, some implementations may relate to automated conferencing systems and methods.

### DESCRIPTION OF RELATED ART

Email and other electronic forms of communication have become overwhelming in volume. Many working professionals now find it difficult to keep track of electronic communications in real time. As a result of electronic communication overload, messages and reminders, including meeting reminders, are sometimes missed. Meeting reminder windows can get buried under other windows on user screens or can otherwise be missed. Accordingly, it is not unheard of for a participant to arrive late or to miss a conference call. Meeting PINS and passwords can also be sources of frustration. Meeting participants sometimes are late for a meeting because the PIN did not work or the attendee could not find the email or invitation with the hard-to-remember PIN.

### BRIEF SUMMARY OF THE DISCLOSURE

According to various embodiments of the disclosed technology, systems and methods are provided to go beyond meeting reminders and to actually call participant attendees when it is time for the conference call to begin. Embodiments may also be configured to enter the meeting ID, PIN, password or other event sign-on information for the participant so the participant doesn't have to remember or track down the sign-on information. Accordingly, the system can be configured to connect a line to the conference bridge on behalf of a user, place a call to that user so the user need not rely on a meeting reminder and handoff the connected line to the user (e.g., bridge or merge the calls) so that the user is automatically, or provide user response/confirmation, connected to the conference bridge on the line connected by the system.

In some embodiments, a method for conference event initiation may include: a calendar API accessing a user calendar and retrieving upcoming conference events for the user on the calendar; a parsing module parsing the retrieved upcoming conference events and storing event information for the upcoming events in an event database, in some embodiments the event information may include event sign-on information; and at a first predetermined time prior to a scheduled conference event, a call module: initiating a call to a host system for the scheduled conference event; placing a call to the user at a second predetermined time prior to the scheduled conference event; and merging the call to the user with the call to the host system to join the user to the scheduled conference event.

In other embodiments, a system for conference event initiation may include: a calendar API configured to access a user calendar and retrieve upcoming conference events for the user on the calendar; a parsing module coupled to the calendar API to receive upcoming conference events retrieved by the calendar API, the parsing module configured to parse the retrieved upcoming conference events and storing event information for the upcoming events in an event database, in some embodiments the event information may include event sign-on information; and a call module coupled to the event database, the call module configured to retrieve event information for a scheduled conference event, and at a first predetermined time prior to a scheduled conference event to: initiate a call to a host system for the scheduled conference event; place a call to the user at a second predetermined time prior to the scheduled conference event; and merge the call to the user with the call to the host system to join the user to the scheduled conference event.

In yet other embodiments, a conference event initiation system may include: a processing system, comprising one or more processors; a memory unit coupled to the processing system and comprising one or more non-transitory storage modules configured to store program instructions, which when executed by the processing system cause the processing system to perform the operations of: accessing a user calendar and retrieving upcoming conference events for the user on the calendar; parsing the retrieved upcoming conference events and storing event information for the upcoming events in an event database, in some embodiments the event information may include event sign-on information; and at a first predetermined time prior to a scheduled conference event: initiating a call to a host system for the scheduled conference event; placing a call to the user at a second predetermined time prior to the scheduled conference event; and merging the call to the user with the call to the host system to join the user to the scheduled conference event.

The systems and methods may further include the call module prompting the user to request user permission prior to merging the call to the user with the call to the host system to join the user to the scheduled conference event.

In some embodiments the event sign-on information may include at least one of a meeting ID, participant ID and meeting password.

The systems and methods may further include announcing the user to the scheduled conference event with a voice announcement. The systems and methods may further include the call module entering event sign-on information to enter the event on behalf of the user. The systems and methods may further include the call module providing, in temporal relation to the call to the user, event sign-on information to the user for the user to enter the event.

In some embodiments the call module provides event sign-on information to the user via a push or SMS notification. In some embodiments merging the call to the user with the call to the host system to join the user to the scheduled conference event may include bridging the call to the user with the call to the host system.

In various embodiments, retrieving upcoming conference events for the user on the calendar comprises obtaining conference event information from the user calendar to create a scheduled conference event in the system, wherein the conference event information comprises date and time of the event and sign-on information for the event. The systems and methods may further include updating the conference event information for the scheduled conference event based on updates made to a meeting entry in the user calendar for that conference event.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a diagram illustrating an example architecture for a conferencing platform in accordance with various systems and methods described herein.

FIGS. 2-5 illustrate an example operational process for event set up for a conference facilitation system in accordance with various embodiments.

FIGS. 6-11 illustrate an example process for conference facilitation in accordance with various embodiments.

FIG. 12 is an example computing component that may be used to implement various features of embodiments described in the present disclosure.

The figures are not exhaustive and do not limit the present disclosure to the precise form disclosed.

### DETAILED DESCRIPTION

Embodiments of the systems and methods disclosed herein can provide systems and methods for connecting one or more calendars and calendar invitations with one or more of a plurality of conference call or other like systems to automate management of conference calls for users. The system may be configured to identify the occurrence of a meeting from a user calendar and also identify the conference call system over which the conference call is to take place. The system can be configured to identify the occurrence of a meeting, dial into the meeting at the designated meeting time, enter meeting sign-on information (e.g., conference ID/PIN/password, etc.), and announce the user/participant, depending on the configuration. The system can be further configured to call the user/participant and transfer the line contacted by the system to the user/participant so that the user/participant is connected to the call on the connected line. In other embodiments, the system can be configured to contact the user/participant first before logging onto the conference call to ensure that the user/participant is available for the conference call.

Accordingly, according to various embodiments, the process can happen automatically without the user having to recognize a reminder or otherwise remember the meeting, without the user having to dial into the conference bridge, and without the user having to enter their PIN. In some embodiments, the system can be configured such that it prompts the user before entering the user into the event. The system can be configured make the connection, call the user and hand over the connection.

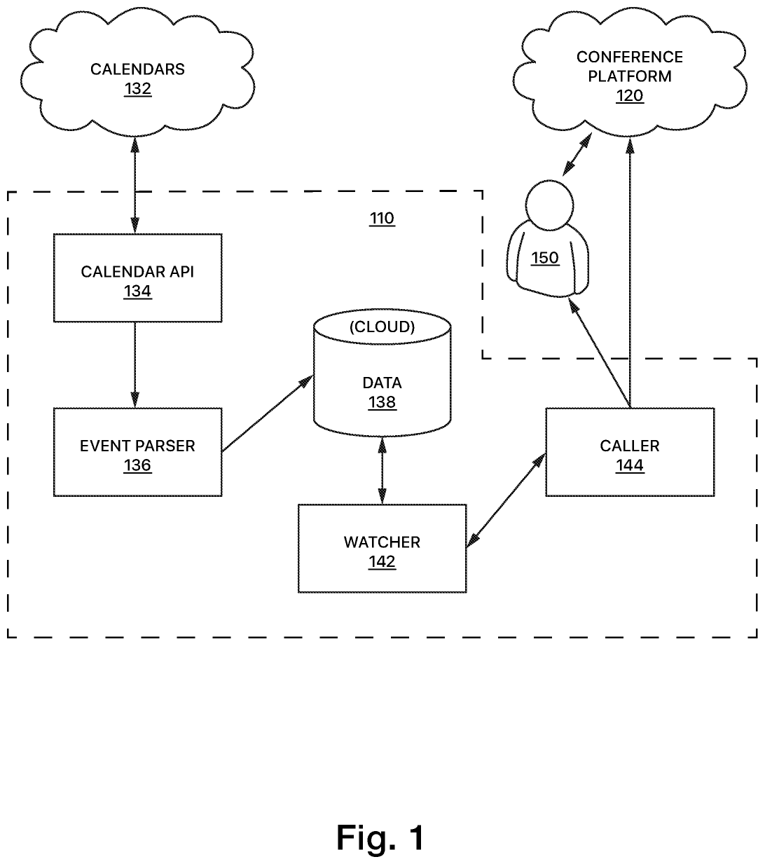

FIG. 1 is a diagram illustrating an example architecture for a conferencing platform in accordance with various systems and methods described herein. This example includes a conference facilitation system 110, one or more cloud-based calendars 132 and one or more conferencing systems or conference platforms 120. In this example, a user may have one or more of a plurality of cloud-based calendars 132 accessible from the cloud, and one or more local calendars (not shown) resident on the user's computing system. An example of cloud-based calendars 132 may include, for example, a Google calendar, Microsoft Outlook, an Apple calendar, and other cloud-based calendar applications.

The conference facilitation system 110 in this example includes a calendar API 134, an event parser 136, a conference system event database 138, a watcher 134 and a caller 144. These modules within conference facilitation system 110 can be configured using one or more computer processing systems or circuits. An example processing system can include one or more GPUs, CPUs, microprocessors or other suitable processors. The processor(s) may include one or more single core or multicore processors, and may execute instructions stored in a non-transitory computer readable medium, such as a memory. The memory may contain instructions (e.g., program logic) executable by processor to execute various functions of conference facilitation system 110, including those of the various modules described below. Conference facilitation system 110 can be a local application on the user's device or it can be a combination of local and cloud-based components.

Calendar API 134 can be configured to provide an interface with local calendars and cloud-based calendars 132. Calendar API 134 can be configured to connect the system to one or more of the user's cloud-based calendars 132, to register with one or more of the user's cloud-based calendars 132, and to receive notifications from connected cloud-based calendars 132. The notifications may include, for example, notifications of calendar events on the calendar and notifications of updates, and modifications to, or cancellation of, such events. In some embodiments, calendar API 134 is granted read access (e.g., read-only access) to cloud-based calendars 132 such that calendar API 134 can read and check for events on the calendars. Calendar API 134 may include wireless or hardwired communication capabilities to communicate with cloud-based calendars 132. This communication interface may be used to communicate registration information and notification information between cloud-based calendars 132 and calendar API 134.

Event parser 136 is communicatively coupled to calendar API 134 and may be configured to receive notification of events (e.g., conference-call meetings) from calendar API 134. These events may be events notified by cloud-based calendars 132 to calendar API 134. In some embodiments, event parser 136 is configured to receive event information in a plurality of different formats and may further be configured to convert the received information into a single, common format specification for conference facilitation system 110. An example format may include a text string of the event information that can be used to populate event database 138.

Event parser 136 may be further configured to store the formatted event in event database 138. The system may also be configured to store events in their native format in event database 138 as well. Accordingly, as calendar events are generated and revised, notifications of such events can be placed into event database 138. Similarly, as events are deleted, they can be removed from event database 138. The system can be configured such that revised events overwrite their existing counterparts in event database 138. As such, conference facilitation system 110 can be configured to maintain an up-to-date, curated list of events for the user in its event database 138. Event database 138 can be a local database, a cloud-based database or a combination of the foregoing.

A watcher 142 can be configured to monitor event database 138 and check for any upcoming events. For example, watcher 142 can be configured to check event database 138 on a periodic or regular basis. It can further be configured to send a notification to caller 144 at a predetermined time before a scheduled event time so that caller 144 can initiate a call into the event. Watcher 142 can further be configured to set timers for upcoming events identified in event database 138 so that watcher 142 can notify caller 144 at the appropriate time for a given event (e.g., at or just prior to the start of the event). Watcher 142 can be a local application, a cloud-based application or a combination of the foregoing.

At a predetermined time prior to the start of an event (e.g., in response to a notification from watcher 142), caller 144 may send a text message or other notification to the user about the event. This can include a simple reminder or notice that conference facilitation system 110 is going to connect the user 150 to the conference call. In some embodiments, the reminder can be sent a predetermined time before caller 144 initiates the call. At a predetermined time prior to the start of the event, caller 144 places a telephone call to user 150. Caller 144 also places a telephone call to the conference platform 120 on which the conference call is to take place. Conference call platforms 120 may include, for example, Zoom, UberConference, Ring Central, GoToMeeting, Google Hangouts, Skype, Soundpath, FreeConferenceCall.com, or other conferencing platforms.

Caller 144 can further be configured to enter conference connection information including, for example, conference ID and PIN information as may be required such that the call can be accepted by and made part of the conference bridge. Caller 144 can merge the calls, effectively handing the conference line over to user 150. Accordingly, various embodiments can be configured to call user 150 so that they do not miss the call, log on to the conference bridge so that user 150 need not remember meeting ID, pin, password or other sign-on information, and hand the call over to user 150 once registered into the conference. In some embodiments, caller 144 can be configured to dial in and log on to the conference bridge before merging the calls or after they are merged.

Caller 144 can be configured to call user 150 before logging onto the conference bridge to ensure that user 150 is available for the call. In some embodiments, caller 144 can be configured to request confirmation from user 150 that user 150 is ready to be connected (e.g., press one if you are ready to be connected to your conference call, press two if you need more time, etc.). In other embodiments, caller 144 can be configured to log on to the conference bridge before calling user 150.

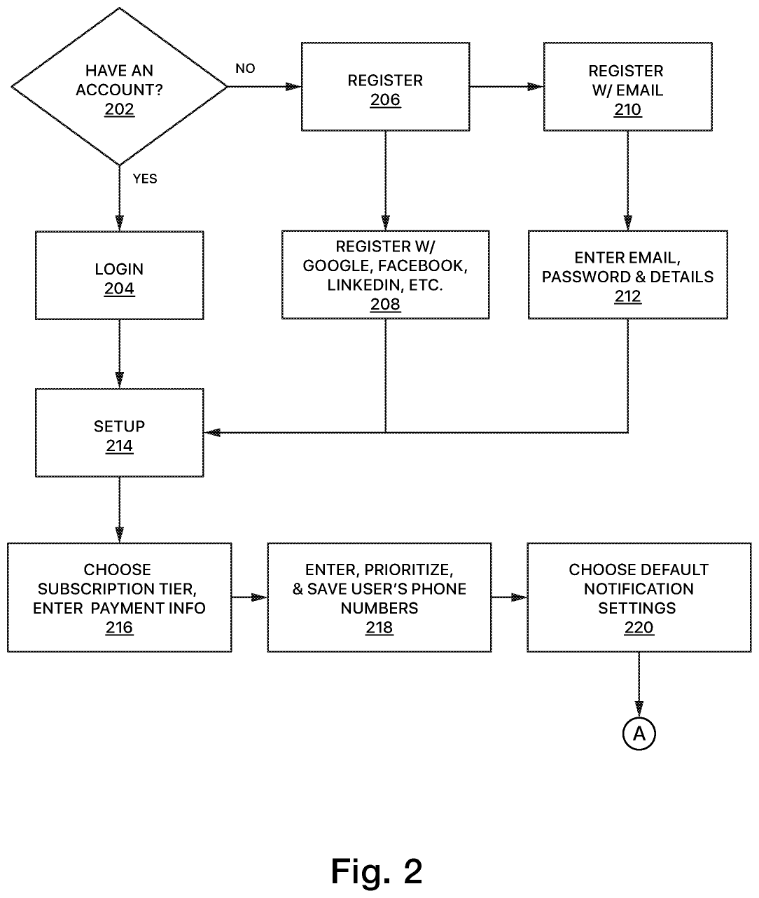

FIGS. 2-5 illustrate an example operational process for event set up for a conference facilitation system in accordance with various embodiments. With reference now to FIG. 2, beginning at operation 202, the system first determines whether a user (e.g., user 150) has an account with the system.

If this is a first time user, the system can be configured to begin the registration process for the user at operation 206. The user can be given options to register using an email address (operation 216) or register using another account such as a Google or Facebook account (operation 208). If the user opts to register via email at operation 216, the system can prompt the user to enter their email address and provide a password to secure the account and request other details as may be appropriate. This occurs at operation 212. After registration (at operation 212, 208) the process then continues at operation 214 for set up.

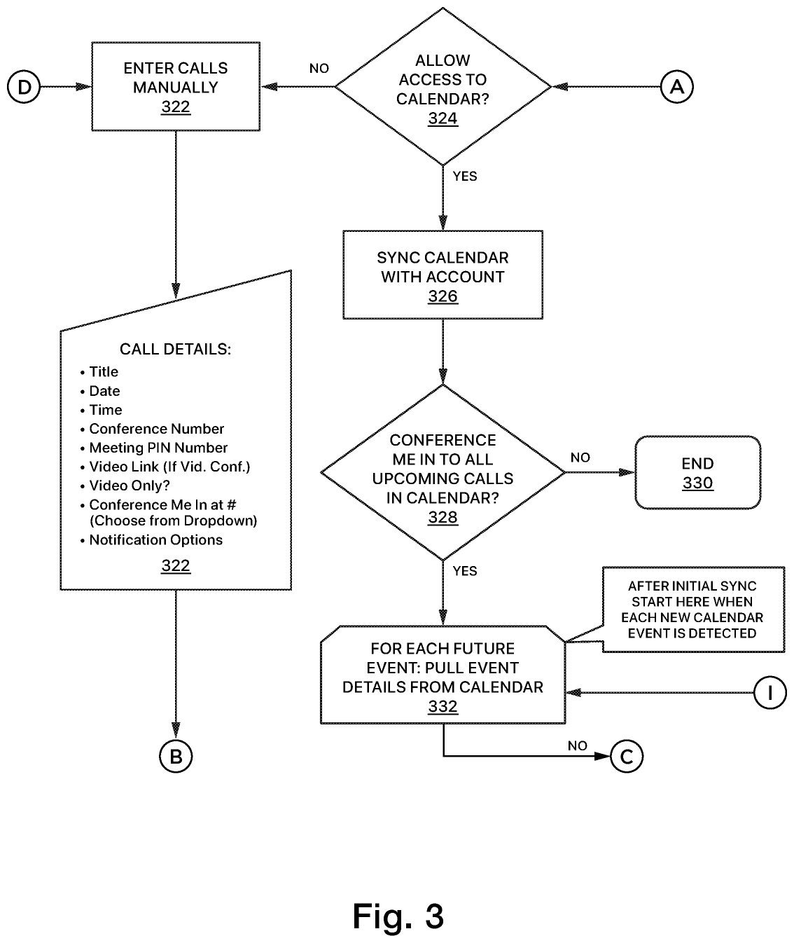

At operation 214, the setup can occur, which may include setting up the user account for new users. At operation 216 the system can prompt the user to select a subscription tier (where multiple tiers are available), and enter payment information to pay for the service. At operation 218, the system can be configured to prompt the user for other information, including setup information, useful to facilitate operation of the system such as, for example, the users telephone numbers. At operation 220 the system may be configured to prompt the user to select notification parameters for default notification settings. This can include, for example, the form, frequency and manner of providing notifications. In some embodiments, registered users logged in at operation 204 may be permitted to skip operations 214-220. Registered users may be permitted to access their settings to update parameters as desired. After account setup, the process proceeds to FIG. 3 at operation 324.

With continued reference to FIG. 2, if the user already has an account with the system (operation 202), the system can present a login screen to the user at operation 204 such that the user can log into the system. Once logged in, the user can be given the option to change settings or enter set-up mode at operation 214. This may include changing calendar access and sync settings (operation 324). Registered users may also be given the option to add calls manually (operations 322, 340).

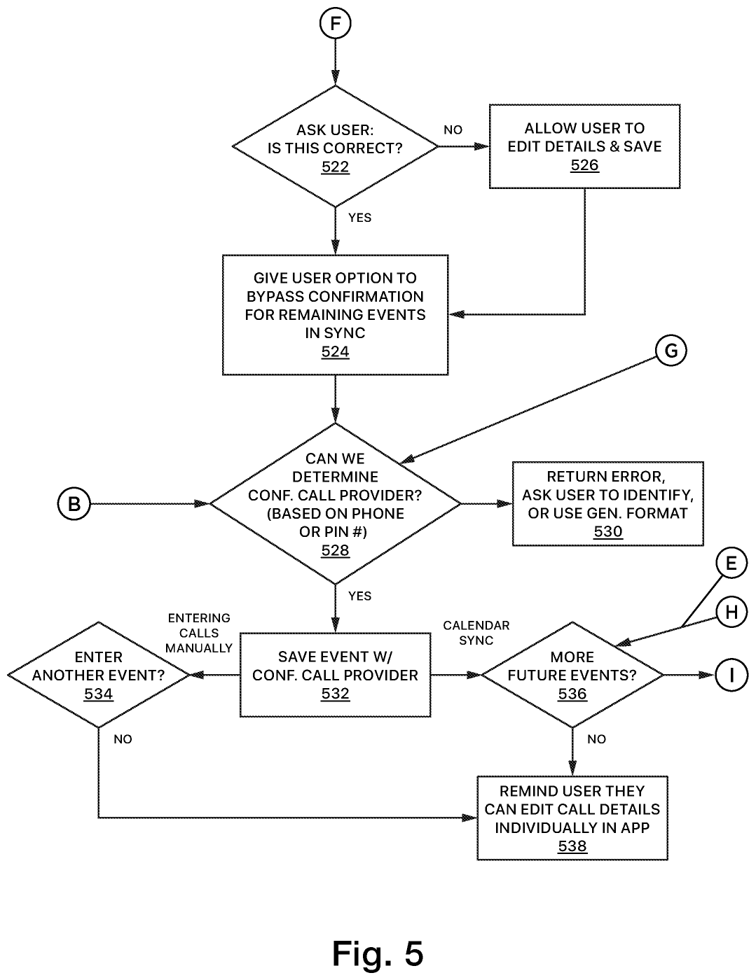

With reference now to FIG. 3, at operation 324, the system prompts the user to give the system permission to access one or more of the users calendars. Where the user does not give permission to access user calendars, at operation 322, the system prompts the user to enter any conference call or other event information manually. For example, at operation 340, the user may be prompted to enter event details including, for example, meeting title, date of event, start time of event, dial-in number, pin number, password and other event sign-on information. Other information may include, for example, whether there is a video link or other videoconference information. The user may also be prompted to enter notification options regarding how the user desires to be notified for the meeting and the system may also prompt the user to enter a number or numbers at which the user is to be called to enter the user into the conference. For example, for some meetings the user may wish to be called at their office line while for other meetings the user may wish to be called on their cell and so on. Upon completion of operation 340, the process may continue at operation 528, described below with reference to FIG. 5.

Returning now to operation 324, where the user does permit the system to access one or more calendars (e.g. cloud-based calendars 132 or local calendars), at operation 326 the system syncs with the permitted calendar or calendars. The system can be configured to access and read calendar events and determine whether there are any upcoming events for potential inclusion in the system database (e.g., event database 138). The system may be configured to capture all events, while in other embodiments the system may be configured to capture events a determined period of time (e.g., 1 day, 5 days, 1 week, 1 month, 3 months, etc.) in the future.

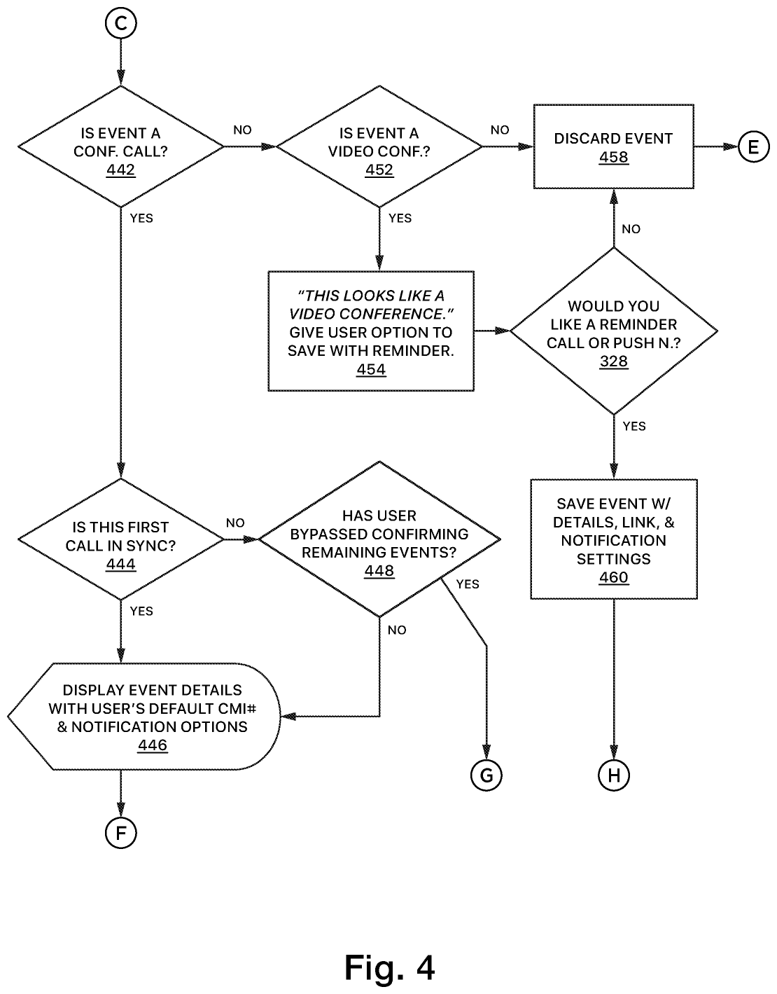

In the illustrated example, at operation 328 the system gives the user the opportunity to identify which meeting or meetings to be registered as part of the conference facilitation system. Where the user indicates that there are no meetings to be included as part of the automatic notification in connection system, the process ends at operation 330. On the other hand, where the user identifies one or more events to be marked in the system, at operation 332, the system pulls the event details for the identified events so that they can be parsed (e.g., by event parser 136) and stored in the system database (e.g. event database 138). Upon completion of operation 332, the process may continue at operation 442, described below with reference to FIG. 4.

Referring now to FIG. 4, at operation 442, the system can determine whether one or more active calendar events (events that the user wishes to be handled by the system) is a conference call. If not, the system can determine whether the event is a videoconference (or other type of conference) at operation 452. If the event is neither a conference call nor a videoconference (or some other event compatible with the system) the event is discarded at operation 458. The process may then continue at operation 536 (described below with reference to FIG. 5) in which the system determines whether there are additional events to be processed.

If at operation 452 the system determines that the event is a videoconference, the system can prompt the user to reply whether the user would like to save a reminder for the videoconference. The user can further be prompted whether they would like the reminder in the form of a call, text or push notification. In other embodiments, other forms of reminders can be provided. This is illustrated at operations 454 and 456. In embodiments where the system only handles telephonic events, the system may still provide a reminder for the videoconference (e.g., as a call, text or push notification) to the user. The notification can include a reminder for the user to go to their computer or other device to join the conference, and a link to the conference to allow the user to access the videoconference using the provided link. If the videoconference has a dial-in option, the system can be configured to call the user and initiate the telephonic audio connection to the video conference as it would for a conference call. In further embodiments, the system can be configured to join the video conference via computer and then link the user's device in through that connection. If the user requests notification of the video event, at operation 460 the system saves the event details and the notification settings (e.g., in event database 138) so that the user can be reminded at a predetermined time before the meeting. The process may then continue at operation 536 (described below with reference to FIG. 5) in which the system determines whether there are additional events to be processed.

Returning now to operation 442, if the event is a conference call or other supported event, the process continues at operation 444 where the system determines if the conference call or other event is the first event parsed by the system based on calendar synchronization. If the conference call is the first event, at operation 446 the system displays event details with the user's default or selected contact number (the number at which to call the user for this particular event) and notification options for the event so that the user may later verify the information. As described below, this information can be used as default settings for other events. The process may then continue at operation 522, described below with reference to FIG. 5.

Returning now to operation 444, if the system determines that the conference call is not the first event, the system then determines at operation 448 whether the user bypassed confirming remaining events. If not, at operation 446, event details for the remaining events are displayed. If the user did bypass confirming remaining events, the process may then continue at operation 528, described below with reference to FIG. 5. The user may bypass confirming remaining events where, for example, the user wishes to apply the same contact and notification information to all of the events synchronized based on calendar information.

Referring now to FIG. 5, at operation 522 the system asks the user to confirm whether the information provided at operation 446 (e.g., the event details such as contact number and notification type) are correct. If the user responds that they are incorrect, at operation 526 the system allows the user to edit the details and save them. If the user responds that they are correct or after the user has corrected the details, at operation 524 the system may provide the user the option to bypass confirmation for any remaining events in the system.

At operation 528, the system determines whether it can identify the conference call platform (e.g., platforms 120) based on the information in the event. For example, the meeting invitation or calendar event may provide direct indication of the conference call platform. As another example, the system may be able to determine this information based on sign-on information such as a conference call dial-in number, meeting URL, meeting ID, PIN, password, and so on. If the system cannot determine the identity of the conference call platform, at operation 530 the system may return an error or as the user to identify the platform or to discard the item from the systems database. In other embodiments, provided that the system has sufficient information to log onto the platform for the event, the system does not care whether it can identify the platform.

Where the system can identify the platform, or if the system has sufficient information such that it does not need to identify the platform, at operation 532 the system saves the event. The saved information can include, for example, date and time of the event, sign-on information such as a dial-in number, meeting URL, meeting ID, PIN, and password and other information. The saved information can also include an identification of the conference call provider, which information may be useful to the system during dial-in operations. In various embodiments, if a meeting entry in a calendar is updated, these updates can be captured by the system and the information saved at operation 532 can be modified to reflect these changes so that the saved event is up to date. For example, changes to event parameters like event date or time, dial-in number, PIN, password, meeting ID etc. can be captured by the system (e.g., by the calendar API) to update events stored in the system database. In this way, the calendar API may retrieve updated parameters for scheduled upcoming events and provide the updated event parameters to update information associated with upcoming events stored in the event database.

Where the user has opted for calendar synchronization (as opposed to manual entry of events), at operation 536 the system determines whether there are additional events to be processed. If so, the process continues at operation 332 (FIG. 3). If at operation 536 the system determines that there are no additional events to be processed, the process is complete for the time being and the system may notify the user that they can edit or review the details of each event in the application or online. This is illustrated operation 538.

Where the user has opted for manual entry of events, at operation 534 the user is given the operation to enter an additional event. If the user does not have any additional events to be entered the process is complete for the time being and the system may notify the user that they can edit or review the details of each event in the application or online. This is illustrated operation 538. If the user does have additional events to be entered, the process may continue at operation 332 (FIG. 3) where the user can enter additional call information.

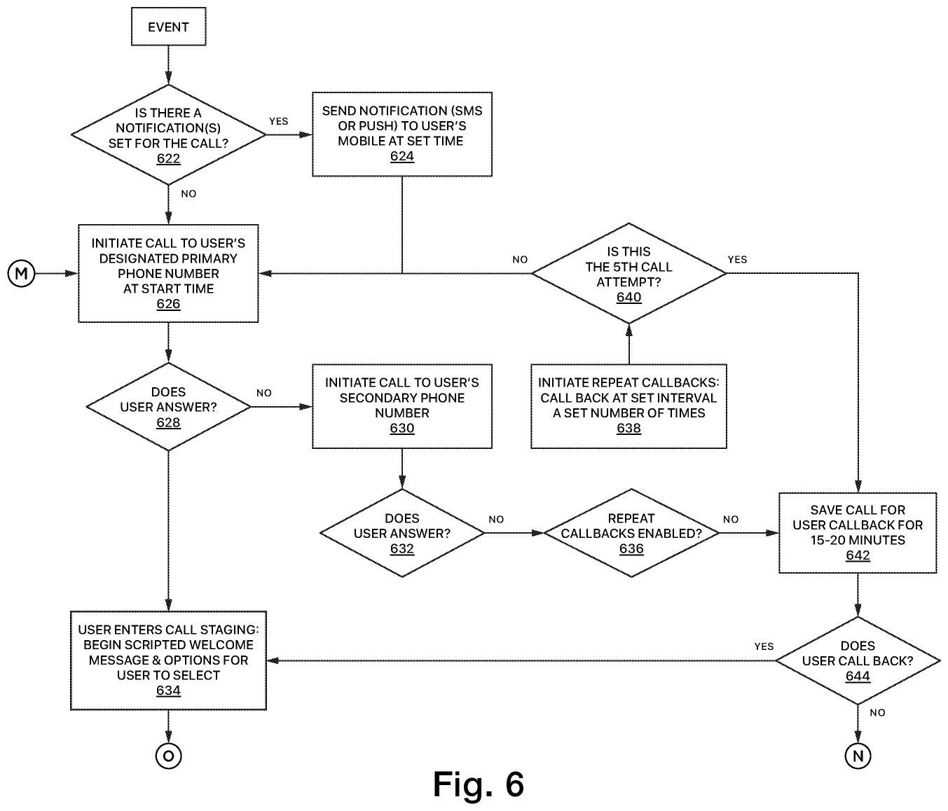

FIGS. 6-11 illustrate an example process for conference facilitation in accordance with various embodiments. The system determines whether there is an upcoming active event. For an upcoming active event, the system determines a type of notification set for the event. At operation 622, the system (e.g., watcher 142 or caller 144) determines whether there are any push notifications for the event. If there are to be one or more push notifications for the event, at operation 624 at the set time, the system sends a push notification to the user's device. For example, the system may send an SMS message or other notification in temporal relation to the event. This can be configured, for example, to give the user a heads up notice that the event is about to take place. In some embodiments, the notification can be scheduled to take place at a designated time that can be established prior to the system placing a call to the user or the conferencing platform that is hosting the event. The designated time for the notification can be set by the system (e.g., one minute, two minutes, three minutes, four minutes, five minutes, etc. before the start of the call. In other applications, the designated time for the notification might be selected by the user during set up as a default for some or all user events for as a setting for the particular event.

If at operation 622 the system determines that there is no push notification for the call, the process continues at operation 626 where the system (e.g. caller 144) initiates a call to the user. For example, the system may initiate a call to the phone number designated by the user as the line on which the user wishes to participate in the event. As noted above, in some embodiments the user can be permitted to select one of a plurality of phone numbers (e.g., home, mobile, office, etc.) on which to take the call. The system can be configured to place this call a predetermined time before the event or at the start of the event. For example, the system can be configured to place the call 20 seconds, 30 seconds, 40 seconds, 50 seconds, one minute, one minute and 10 seconds, two minutes, three minutes, or any set predetermined time before the event. In some embodiments, the set time can be established by the user.

Once the call is placed, the system determines at operation 628 whether the user answers the call. If the user answers the call, at operation 634 the system places the user into the call staging mode. During call staging, the user may be instructed to wait until the conference call is connected and the user may be given options during this time. If, on the other hand, at operation 628 the system determines that the user does not answer, the system may terminate the call and try again after a predetermined time (e.g., the system may proceed to operation 636 (described below) directly, without going through operation 630 and 632). Alternatively, as illustrated in the example of FIG. 6, if the user doesn't answer the call, the system may initiate a call to the users secondary, tertiary (etc.) telephone number as illustrated at operation 630. If the user answers this line, the system proceeds to operation 634 where the user is placed into the call staging mode as described above.

On the other hand, if the user does not answer the secondary line the system can determine whether a stalker mode is enabled at operation 636. A stalker mode is a mode in which the system makes one or more repeated attempts to reach the user. In some embodiments, stalker mode may be enabled by user through user settings. In other embodiments, stalker mode may be a system setting. In either case, if stalker mode is enabled, at operation 638 the system initiates the stalker protocol and calls user again to give the user the opportunity to answer. The system may be configured to call the user at determined or periodic intervals such as, for example, every minute, every two minutes, every three minutes, etc.). This may enable the system to catch the user if for example the user was simply unable to answer on the first call. Stalker mode may be configured to call the primary number or the secondary number, or both, depending on system settings.

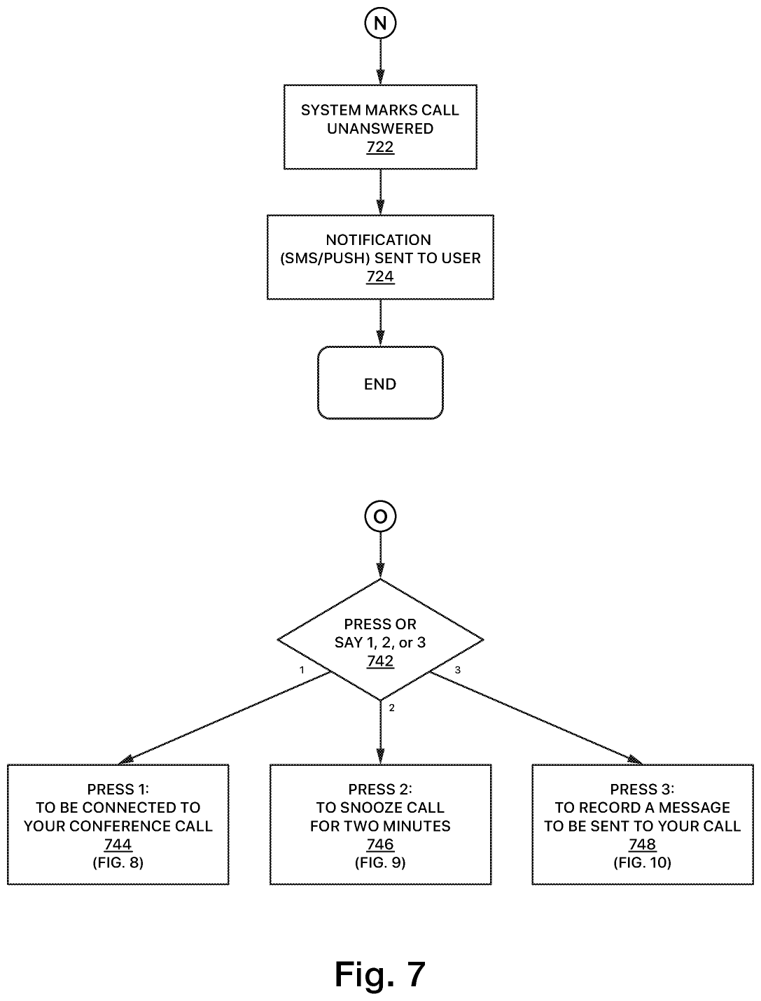

If after a predetermined number of attempts, which may be a user setting in some embodiments, (five attempts are shown in the example of FIG. 6) the caller still does not answer, the system can be configured to either end the process for this event or to save the call for user call back at a later time (e.g., save for five minutes, 10 minutes, 15 minutes, 20 minutes, one half hour or other amount of time) as illustrated at operation 642. If the event is safe for call back and the user does call back as illustrated at operation 644, the system can place the user into call staging mode at operation 634. If the user does not call back, the process continues at operation 722 as described below in FIG. 7.

The system can be configured, such that at any point during the above process of failed attempts to call the user, the system employs other forms of notification such as text, email, or other alerts. The system can also be configured to receive a return text such as, for example, a text from the user indicating that user is tied up and not able to join the conference call at the present time. The user may be given the option to join the conference call later or elect not to join at all.

Referring now to FIG. 7, at operation 722, if the user does not call back the system marks the call as unanswered. As illustrated in this example, the system has tried to call the user and did not receive an answer. The system even tried in this example multiple numbers and made multiple callbacks and still did not receive an answer. Accordingly, as noted, the system marks the call as unanswered. In other embodiments, the system may be configured to only try once or to try only one number as opposed to trying multiple numbers. Such configurations can be set by system designers or the system may be configured such that these options are user selectable.

At operation 724, the system can be configured to send the user a final notification informing the user that they missed the call. For example, the system may be configured to leave a voicemail message, send a text message, send an email message, or otherwise alert the user of the failed attempt.

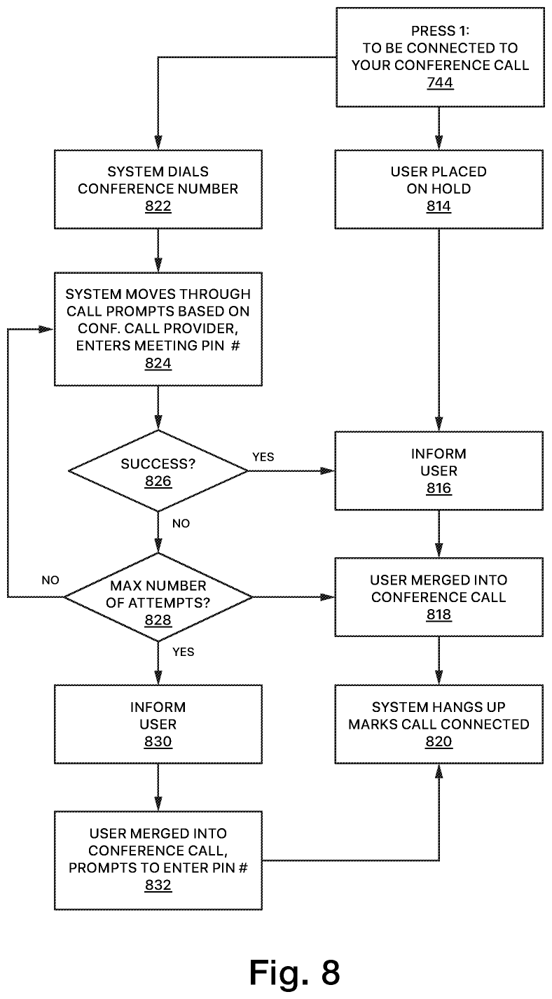

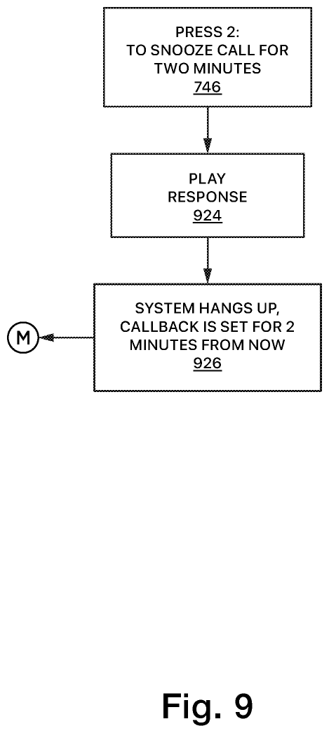

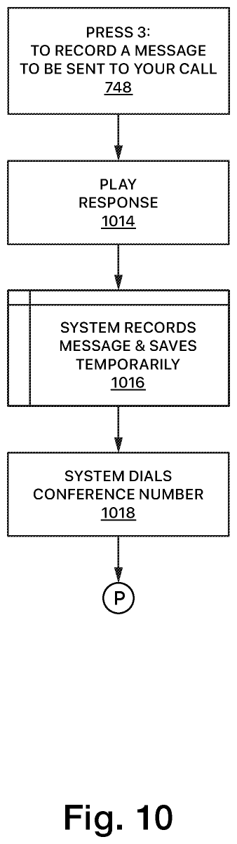

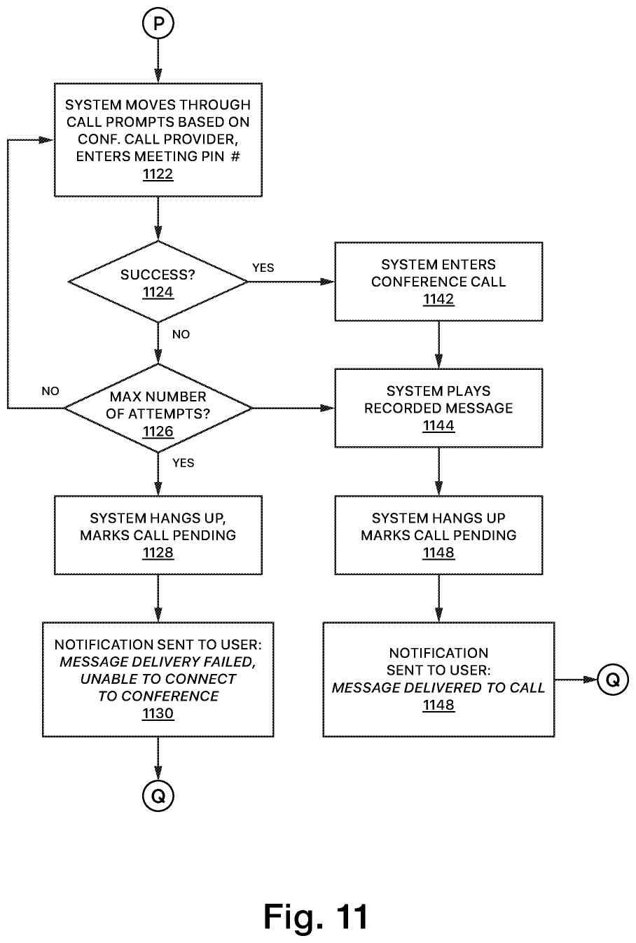

Referring back now to FIG. 6, once the system places the caller in the staging area, the process continues at operation 742 (FIG. 7) where the user may be given options for the event. In the example illustrated in FIG. 7, the user is given three options. In other embodiments other options and other quantities of options may be given to the user. In this example, the three options are to be immediately connected to the conference call 744 (FIG. 8), to snooze before entering the call for a determined period of time (two minutes in the illustrated example, although other periods of time are configurable) 746 (FIG. 9) or to record a message to be sent to the event 748 (FIGS. 10 and 11). Each of these options are now described with reference to their corresponding FIGS. 8-11.

FIG. 8 illustrates a process for immediate connection into the conference call. As seen this example, at operation 814 the user is placed on hold while the system attempts to connect to the conference bridge. The system can be configured to provide a message to the user that they are being placed on hold while the system conferences them in. Meanwhile, at operation 822 the system dials the conference number to attempt to enter the conference. At operation 824, the system navigates through the call prompts provided by the conference call provider and enters required information such as, for example, meeting ID, PIN, user ID, password, or other information. In some embodiments, the system may also be configured to provide a voice introduction for the user such as, the user's name, if the system prompts for the user to state their name upon entering the call. The voice introduction can be a synthesized voice of the user's name from the user account information or it can be a recorded introduction from the user that is recorded during set up.

If entry into the conference call is successful as illustrated at operation 826, the system informs the user at operation 816 that they are being placed into the conference. At operation 818, the calls are merged in the user is merged into the conference call. At operation 820, the system can hang up its call because the user is now connected. At this time, the process may be completed.

If on the other hand, the system is unsuccessful entering the conference call, it may make one or more retry attempts until it is successful entering the call or until a maximum number of attempts or a timeout is reached. If the system is ultimately successful, the process continues at operations 816, 818 & 820, as described above. If the operation is unsuccessful after a predetermined number of attempts or a timeout period, at operation 830 the system informs the user that it was unable to successfully enter the meeting. At this time, the system can give the user the option to be merged into the call to enter the conference information (e.g., meeting number, PIN, etc.) manually. This is illustrated at operation 832. After the system hence the call over to the user to enter the meeting, the system can exit the process as illustrated at operation 820.

FIG. 9 illustrates a process for proceeding if the user opted to snooze the call for a period of time (operation 746). If this is the case, at operation 924 the system can be configured to play a response to the user indicating that they are being snoozed and the system will call them back in the allotted time. At operation 926, the system hangs up and a call back is set for the predetermined snooze time. The process may then return to operation 626 at FIG. 6.

FIG. 10 illustrates a process for recording a message to be sent to the conference call (operation 748). In this example, at operation 1014, the system plays instructions instructing the user to record a message to be sent to the conference call. For example, the system can state to the user “at the tone, please record your message. Your message will be patched directly into your conference call line for your fellow callers to hear.” The user can then state a message that it would like to have played to the participants. For example, the user may wish to record a message telling the other participants of the event that the user is sorry they cannot make it, or that the user is running late and will join as soon as they can.

At operation 1016, the system records the message and saves it (e.g., temporarily). The message may be saved, for example, in event database 138. At operation 1018, the system dials the conference number. At this point, the process may then proceed at operation 1122 of FIG. 11.

With reference now to FIG. 11, at operation 1122, the system calls the conference line, and moves to the prompts to enter required information such as, for example, meeting ID, PIN, password, etc. As noted above with reference to FIG. 8, in some embodiments, the system may also be configured to provide a voice introduction for the user such as, the user's name, if the system prompts for the user to state their name upon entering the call. The voice introduction can be synthesized voice of the user's name from the user account information or it can be a recorded introduction from the user that is recorded during set up or later through system settings.

If as illustrated at operation 1124 the attempt to enter the conference call is successful, the system enters the call at operation 1142. Once entered, at operation 1144 the system plays the recorded message so that the participants on the line can hear the user's message. In some embodiments, the system can be configured to play the recorded message immediately upon connection into the conference. In other embodiments, the system can be configured to wait to play the message until a determined number of participants have joined the meeting. In yet other embodiments, the system can be configured to wait before playing the message until the system hears other voices talking in the meeting. Waiting to play the message can help avoid a scenario in which the message is played to a conference line on which there are no other participants.

At operation 1146, after playing the message the system hangs up and marks the call pending. At operation 1148 the system may be configured to send a notification to the user confirming that the recorded message was played to the participants. The process may then continue at operation 644 of FIG. 6.

Returning now to operation 1124, if the system is not successful joining the conference call, the system may retry until the system times out or maximum number of attempts has been reached. This is illustrated at operation 1126. If the system has timed out or maximum number of attempts have been reached, the system hangs up the call at operation 1128. Accordingly, at operation 1130, the system sends a push notification to the user indicating that message delivery has failed. The process may then continue at operation 644 of FIG. 6.

The term “coupled” refers to direct or indirect joining, connecting, fastening, contacting or linking, and may refer to various forms of coupling such as physical, optical, electrical, fluidic, mechanical, chemical, magnetic, electromagnetic, optical, communicative or other coupling, or a combination of the foregoing. Where one form of coupling is specified, this does not imply that other forms of coupling are excluded. For example, one component physically coupled to another component may reference physical attachment of or contact between the two components (directly or indirectly), but does not exclude other forms of coupling between the components such as, for example, a communications link (e.g., an RF, hardwired or optical link) also communicatively coupling the two components. Likewise, the various terms themselves are not intended to be mutually exclusive. For example, a fluidic coupling, magnetic coupling or a mechanical coupling, among others, may be a form of physical coupling.

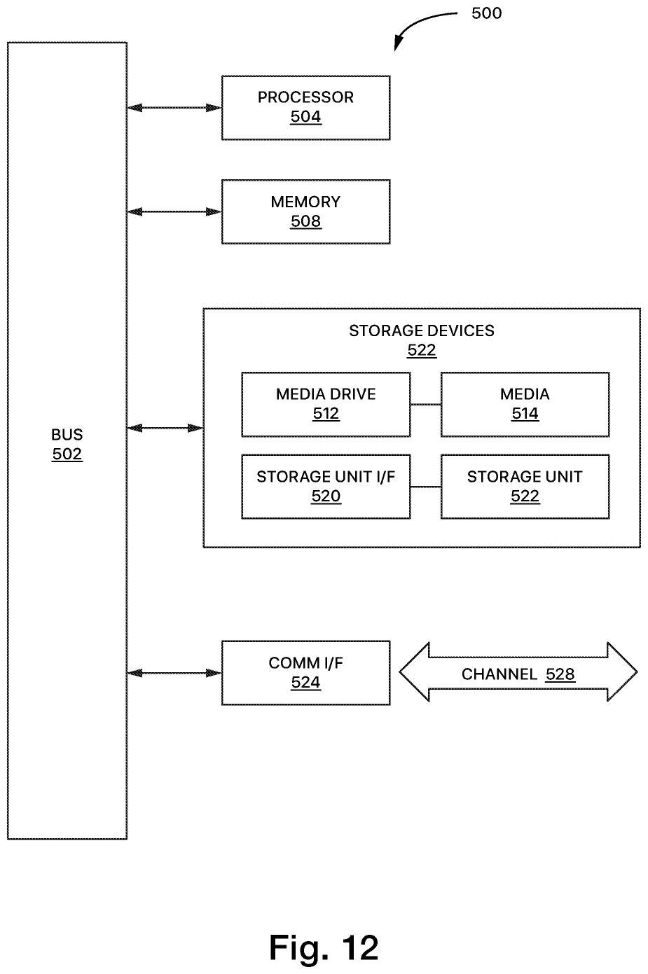

As used herein, the terms module, circuit and component might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 12. Various embodiments are described in terms of this example-computing component 1200. After reading this description, it will become apparent to a person skilled in the relevant art how to implement the application using other computing components or architectures.

Referring now to FIG. 12, computing component 1200 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 1200 might also represent computing capabilities embedded within or otherwise available to a given device. For example, a computing component might be found in other electronic devices such as, for example, portable computing devices, and other electronic devices that might include some form of processing capability.

Computing component 1200 might include, for example, one or more processors, controllers, control components, or other processing devices. Processor 1204 might be implemented using a general-purpose or special-purpose processing engine such as, for example, a microprocessor, controller, or other control logic. Processor 1204 may be connected to a bus 1202. However, any communication medium can be used to facilitate interaction with other components of computing component 1200 or to communicate externally.

Computing component 1200 might also include one or more memory components, simply referred to herein as main memory 1208. For example, random access memory (RAM) or other dynamic memory, might be used for storing information and instructions to be executed by processor 1204. Main memory 1208 might also be used for storing temporary variables or other intermediate information during execution of instructions to be executed by processor 1204. Computing component 1200 might likewise include a read only memory (“ROM”) or other static storage device coupled to bus 1202 for storing static information and instructions for processor 1204.

The computing component 1200 might also include one or more various forms of information storage mechanism 1210, which might include, for example, a media drive 1212 and a storage unit interface 1220. The media drive 1212 might include a drive or other mechanism to support fixed or removable storage media 1214. For example, a hard disk drive, a solid-state drive, a magnetic tape drive, an optical drive, a compact disc (CD) or digital video disc (DVD) drive (R or RW), or other removable or fixed media drive might be provided. Storage media 1214 might include, for example, a hard disk, an integrated circuit assembly, magnetic tape, cartridge, optical disk, a CD or DVD. Storage media 1214 may be any other fixed or removable medium that is read by, written to or accessed by media drive 1212. As these examples illustrate, the storage media 1214 can include a computer usable storage medium having stored therein computer software or data.

In alternative embodiments, information storage mechanism 1210 might include other similar instrumentalities for allowing computer programs or other instructions or data to be loaded into computing component 1200. Such instrumentalities might include, for example, a fixed or removable storage unit 1222 and an interface 1220. Examples of such storage units 1222 and interfaces 1220 can include a program cartridge and cartridge interface, a removable memory (for example, a flash memory or other removable memory component) and memory slot. Other examples may include a PCMCIA slot and card, and other fixed or removable storage units 1222 and interfaces 1220 that allow software and data to be transferred from storage unit 1222 to computing component 1200.

Computing component 1200 might also include a communications interface 1224. Communications interface 1224 might be used to allow software and data to be transferred between computing component 1200 and external devices. Examples of communications interface 1224 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 1224 may be carried on signals, which can be electronic, electromagnetic (which includes optical) or other signals capable of being exchanged by a given communications interface 1224. These signals might be provided to communications interface 1224 via a channel 1228. Channel 1228 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 1208, storage unit 1220, media 1214, and channel 1228. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 1200 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for conference event initiation, comprising:
a calendar API accessing a user calendar and retrieving upcoming conference events for the user on the calendar;
a parsing module parsing the retrieved upcoming conference events and storing event information for the upcoming events in an event database, wherein the event information comprises event sign-on information; and
at a first predetermined time prior to a scheduled conference event, a call module:
initiating a call to a host system for the scheduled conference event;
placing a call to the user at a second predetermined time prior to the scheduled conference event; and
merging the call to the user with the call to the host system to join the user to the scheduled conference event.

2. The method of claim 1, further comprising the call module prompting the user to request user permission prior to merging the call to the user with the call to the host system to join the user to the scheduled conference event.

3. The method of claim 1, wherein the event sign-on information comprises at least one of a meeting ID, participant ID and meeting password.

4. The method of claim 1, further comprising announcing the user to the scheduled conference event with a voice announcement.

5. The method of claim 1, further comprising the call module entering event sign-on information to enter the event on behalf of the user.

6. The method of claim 1, further comprising the call module providing, in temporal relation to the call to the user, event sign-on information to the user for the user to enter the event.

7. The method of claim 6, wherein the call module provides event sign-on information to the user via a push or SMS notification.

8. The method of claim 1, wherein merging the call to the user with the call to the host system to join the user to the scheduled conference event comprises bridging the call to the user with the call to the host system.

9. The method of claim 1, wherein retrieving upcoming conference events for the user on the calendar comprises obtaining conference event information from the user calendar to create a scheduled conference event in the system, wherein the conference event information comprises date and time of the event and sign-on information for the event.

10. The method of claim 9, further comprising the updating the conference event information for the scheduled conference event based on updates made to a meeting entry in the user calendar for that conference event.

11. The method of claim 1, further comprising the calendar API accessing the user calendar, retrieving updated parameters for scheduled upcoming conference events and providing the updated parameters to update information associated with upcoming events stored in the event database.

12. A system for conference event initiation, comprising:
a calendar API configured to access a user calendar and retrieve upcoming conference events for the user on the calendar;
a parsing module coupled to the calendar API to receive upcoming conference events retrieved by the calendar API, the parsing module configured to parse the retrieved upcoming conference events and storing event information for the upcoming events in an event database, wherein the event information comprises event sign-on information; and
a call module coupled to the event database, the call module configured to retrieve event information for a scheduled conference event, and at a first predetermined time prior to a scheduled conference event to:
initiate a call to a host system for the scheduled conference event;
place a call to the user at a second predetermined time prior to the scheduled conference event; and
merge the call to the user with the call to the host system to join the user to the scheduled conference event.

13. The system of claim 12, wherein the call module is further configured to prompt the user to request user permission prior to merging the call to the user with the call to the host system to join the user to the scheduled conference event.

14. The system of claim 12, wherein the event sign-on information comprises at least one of a meeting ID, participant ID and meeting password.

15. The system of claim 12, wherein the call module is further configured to announce the user to the scheduled conference event with a voice announcement.

16. The system of claim 12, wherein the call module is further configured to enter event sign-on information to enter the event on behalf of the user.

17. The system of claim 12, wherein the call module is further configured to provide, in temporal relation to the call to the user, event sign-on information to the user for the user to enter the event.

18. The system of claim 17, wherein the call module provides event sign-on information to the user via a push or SMS notification.

19. The system of claim 12, wherein merging the call to the user with the call to the host system to join the user to the scheduled conference event comprises bridging the call to the user with the call to the host system.

20. The system of claim 12, wherein retrieving upcoming conference events for the user on the calendar comprises obtaining conference event information from the user calendar to create a scheduled conference event in the system, wherein the conference event information comprises date and time of the event and sign-on information for the event.

21. The system of claim 20, further comprising the updating the conference event information for the scheduled conference event based on updates made to a meeting entry in the user calendar for that conference event.

22. The system of claim 12, wherein the calendar API is further configured access the user calendar, retrieve updated parameters for scheduled upcoming conference events and provide the updated parameters to update information associated with upcoming events stored in the event database.

23. A conference event initiation system, comprising:
A processing system, comprising one or more processors;
A memory unit coupled to the processing system and comprising one or more non-transitory storage modules configured to store program instructions, which when executed by the processing system cause the processing system to perform the operations of:
accessing a user calendar and retrieving upcoming conference events for the user on the calendar;
parsing the retrieved upcoming conference events and storing event information for the upcoming events in an event database, wherein the event information comprises event sign-on information; and
at a first predetermined time prior to a scheduled conference event:
initiating a call to a host system for the scheduled conference event;
placing a call to the user at a second predetermined time prior to the scheduled conference event; and
merging the call to the user with the call to the host system to join the user to the scheduled conference event.

24. The system of claim 23, wherein the operations performed by the processing system further comprise the call module prompting the user to request user permission prior to merging the call to the user with the call to the host system to join the user to the scheduled conference event.

25. The system of claim 23, wherein the event sign-on information comprises at least one of a meeting ID, participant ID and meeting password.

26. The system of claim 23, wherein the operations performed by the processing system announcing the user to the scheduled conference event with a voice announcement.

27. The system of claim 23, wherein the operations performed by the processing system entering event sign-on information to enter the event on behalf of the user.

28. The system of claim 23, wherein the operations performed by the processing system providing, in temporal relation to the call to the user, event sign-on information to the user for the user to enter the event.

29. The system of claim 28, wherein the call module provides event sign-on information to the user via a push or SMS notification.

30. The system of claim 23, wherein retrieving upcoming conference events for the user on the calendar comprises obtaining conference event information from the user calendar to create a scheduled conference event in the system, wherein the conference event information comprises date and time of the event and sign-on information for the event.

31. The system of claim 30, further comprising the updating the conference event information for the scheduled conference event based on updates made to a meeting entry in the user calendar for that conference event.

32. The system of claim 23, wherein the operations further comprise accessing the user calendar, retrieving updated parameters for scheduled upcoming conference events and providing the updated parameters to update information associated with upcoming events stored in the event database.
